(19) United States
(12) Patent Application Publication
(10) Pub. No.: US 2025/0134126 A1
(43) Pub. Date: May 1, 2025

(54) A COMPOSITION FOR MAKING A DRINK, A METHOD FOR PRODUCING A COMPOSITION, AN APPARATUS FOR PRODUCING A COMPOSITION AND USE OF AN ANTACID INGREDIENT

(71) Applicant: RA HYGGE ASP, Slangerup (DK)

(72) Inventor: Irina Sandberg, Slangerup (DK)

(73) Assignee: RA HYGGE ASP, Slangerup (DK)

(21) Appl. No.: 18/690,726

(22) PCT Filed: Sep. 12, 2022
(86) PCT No.: PCT/EP2022/075267

§ 371 Date: Mar. 9, 2024

(30) Foreign Application Priority Data
Sep. 13, 2021 (FI) 20215958

(51) Int. Cl. A23F 5/40; A23F 5/42

(52) U.S. Cl. CPC A23F 5/40; A23F 5/405; A23F 5/42

(57) ABSTRACT

A composition for making a drink includes a coffee bean ingredient, an antacid ingredient, a polysaccharide ingredient having an extract from mushroom, and solid particles including the coffee bean ingredient, the antacid ingredient and the polysaccharide ingredient. The composition includes the coffee bean ingredient from 80 wt-% to 99 wt-% based on a total weight of the composition, the antacid ingredient from 0.5 wt-% to 10 wt-% based on the total weight of the composition, and the polysaccharide ingredient from 0.5 wt-% to 10 wt-% based on the total weight of the composition.

### CROSS REFERENCE TO RELATED APPLICATIONS

The present application claims the priority benefits of International Patent Application No. PCT/EP2022/075267, filed on Sep. 12, 2022, and claims benefit of FI 20215958, filed on Sep. 13, 2021, which are hereby incorporated herein by reference in their entireties.

### FIELD OF THE INVENTION

The present invention relates to a composition for making a drink and a method, apparatus, and use of an antacid ingredient for producing the composition for making the drink.

### BACKGROUND OF THE INVENTION

In the prior art most coffee varieties are acidic, with an average pH value of 4.85 to 5.10. Such an acidic drink may irritate stomach. Drinking too many acidic drinks may cause also an erosion of enamel. In a prior art is known to take separately antacids to prevent problems caused by the acidic drink. It is also to known to add an antacid into a drink.

One of the problems associated with the prior art is that compositions for making a coffee drink do no not comprise antacid.

One of the problems associated with the prior art is that one must have a separate antacid and one must know how much antacid one should add into a drink to achieve a drink having a reasonable acidity. This is complicate and the result may be unwanted.

Antacid in a solid particle form may not be mixed with coffee beans or to grounded coffee beans or instant coffee particles before brewing a coffee because different types of particles in a composition sort into separate layers. Sorting occurs especially when the composition is moved for instance during transportation. This means that particles of an antacid would be distributed unevenly in the composition. Further, acidity of the drinks would vary a lot such that antacid does not affect at all to some of the drinks made of the composition.

Many antacids do not stick on surfaces. This means that for instance baking soda mixed with coffee beans sort into a separate layer when the composition is moved for instance during transportation.

### SUMMARY OF THE INVENTION

An object of the present invention is to provide a composition for making a drink, a method for producing a composition, an apparatus for producing a composition and use of an antacid ingredient as to solve or at least alleviate the prior art disadvantages.

The preferred embodiments of the invention are disclosed in the dependent claims.

The invention is based on the idea of providing a composition for making a drink, the composition comprises a coffee bean ingredient and an antacid ingredient.

The composition comprises solid particles comprising the coffee bean ingredient. The antacid ingredient and the polysaccharide ingredient. The composition comprises the coffee bean ingredient from 80 wt-% to 99 wt-% based on a total weight of the composition, the antacid ingredient from 0.5 wt-% to 10 wt-% based on a total weight of the composition, and the polysaccharide ingredient from 0.5 wt-% to 10 wt-% based on a total weight of the composition.

In one embodiment, the coffee bean ingredient, the antacid ingredient, and the polysaccharide ingredient adds up to 100 wt %.

In an alternative embodiment, the coffee bean ingredient, the antacid ingredient, and the polysaccharide ingredient and water adds up to 100 wt %.

In one embodiment the antacid ingredient comprises a salt of aluminium, a salt of calcium, a salt of magnesium, a salt of sodium, magnesium carbonate, aluminium hydroxide or a combination thereof.

These are typical compounds used as an antacid.

In an alternative embodiment, the antacid ingredient comprises sodium bicarbonate.

Typically, sodium bicarbonate does not have side effects.

In another alternative embodiment, the antacid ingredient comprises sodium carbonate.

Sodium carbonate is widely used in a food industry.
In a yet alternative embodiment, the antacid ingredient consists of sodium bicarbonate.

Typically, sodium bicarbonate does not have side effects.

In one embodiment, the composition further comprises a polysaccharide ingredient.

Polysaccharide ingredient provide particles comprising the antacid ingredient, the coffee bean ingredient and the polysaccharide ingredient.

In one embodiment, the composition further comprises a polysaccharide ingredient comprising a natural extract comprising polysaccharides.

Natural extracts may be used for changing a taste of the coffee and at the same time for providing particles comprising the antacid ingredient, the coffee bean ingredient and the polysaccharide ingredient.

In one embodiment, the composition further comprises a polysaccharide ingredient comprising an extract from mushroom.

An extract from mushroom extracts may be used for prolonging an effect of the caffeine and at the same time for providing particles comprising the antacid ingredient, the coffee bean ingredient and the polysaccharide ingredient.

In one embodiment, the composition further comprises a polysaccharide ingredient comprising an extract from gingseng.

Extracts from gingseng boost energy, lower blood sugar and cholesterol levels and at the same time provide particles comprising the antacid ingredient, the coffee bean ingredient and the polysaccharide ingredient.

In one embodiment, the composition further comprises a polysaccharide ingredient comprising a natural extract, the natural extract comprises polysaccharides from 10 wt-% to 90 wt-% based on a total weight of the extract.

This range of polysaccharides is advantageous for providing particles comprising the antacid ingredient, the coffee bean ingredient and the polysaccharide ingredient.

In one embodiment, the composition further comprises a polysaccharide ingredient comprising a natural extract, the natural extract comprises polysaccharides from 25 wt-% to 35 wt-% based on a total weight of the extract.

This range of polysaccharides is advantageous for providing particles comprising the antacid ingredient, the coffee bean ingredient and the polysaccharide ingredient and an extract having this range of polysaccharides is easy to produce.

In one embodiment, the composition further comprises a polysaccharide ingredient comprising an extract from mushroom, the extract from mushroom comprises polysaccharides from 10 wt-% to 90 wt-% based on a total weight of the extract.

This range of polysaccharides is advantageous for providing particles comprising the antacid ingredient, the coffee bean ingredient and the polysaccharide ingredient.

In one embodiment, the composition further comprises a polysaccharide ingredient comprising an extract from mushroom, the extract from mushroom comprises polysaccharides from 25 wt-% to 35 wt-% based on a total weight of the extract.

This range of polysaccharides is advantageous for providing particles comprising the antacid ingredient, the coffee bean ingredient and the polysaccharide ingredient and an extract having this range of polysaccharides is easy to produce.

In one embodiment, the polysaccharide ingredient comprises β-glucan.

In one embodiment, the polysaccharide ingredient comprises β-1.6-glucan.

In one embodiment, the polysaccharide ingredient comprises chitin.

In one embodiment, the polysaccharide ingredient comprises acidic polysaccharide ginsenan PA and acidic polysaccharide ginsenan PB.

In one embodiment, the polysaccharide ingredient comprises β-glucan, β-1,6 glucan, chitin, acidic polysaccharide ginsenan PA and acidic polysaccharide ginsenan PB, or any combination thereof.

β-Glucans (beta-glucans) comprise a group of β-D-glucose polysaccharides naturally occurring in the cell walls of cereals, bacteria, and fungi, with significantly differing physicochemical properties dependent on source. Typically, ˜-glucans form a linear backbone with 1-3 ˜-glycosidic bonds but vary 5 with respect to molecular mass, solubility, viscosity, branching structure, and gelation properties, causing diverse physiological effects in animals.

Whereas a-glucans and β-1,3-glucan can be found also in the cell wall of plants, β-1,6-glucan has been found only in the cell wall of fungi and of members of the phylum Chromista, such as in the oomycetes of the genera Phytophtora and Phytium.

Chitin (CsH13OsN) n is a long-chain polymer of N-acetylglucosamine, an amide derivative of glucose. This polysaccharide is a primary component of cell walls in fungi.

Gingseng comprises acidic polysaccharides ginsenan PA and ginsenan 15 PB. An acidic polysaccharides ginsenan PA has a molecular weight of 16,000 and arabino-β-3,6-galactan-type structural unit. An acidic polysaccharides ginsenan PB has a molecular weight of 5,500, and rhamnogalacturonan-type structural unit. At dietary intake levels of at least 3 g per day, oat fiber ˜-glucan decreases blood levels of LDL cholesterol and so may reduce the risk of cardiovascular diseases.

In one embodiment, the composition comprises water less than 15-wt % based on a total weight of the composition.

In one embodiment, the composition comprises water less than 5 wt-% based on a total weight of the coffee bean ingredient.

In one embodiment, the coffee bean ingredient comprises water less than 5 wt-% based on a total weight of the coffee bean ingredient.

In one embodiment, the coffee bean ingredient comprises whole roasted coffee beans.

In one embodiment, the coffee bean ingredient comprises grinded coffee beans having particles size from 100 μm to 1.2 mm.

In one embodiment, the coffee bean ingredient comprises grinded coffee beans having particles size from 0.3 mm to 1.2 mm.

In one embodiment, the coffee bean ingredient comprises grinded coffee beans having particles size from 0.8 mm to 1.2 mm.

In one embodiment, the coffee bean ingredient comprises grinded coffee beans having particles size from 0.65 mm to 0.8 mm.

In one embodiment, the coffee bean ingredient comprises grinded coffee beans having particles size from 0.3 mm to 0.5 mm.

In one embodiment, the coffee bean ingredient comprises grinded coffee beans having particles size from 100 μm to 400 μm.

In one embodiment, the composition comprises water less than 15 wt-% based on a total weight of the coffee bean ingredient.

In one embodiment, the coffee bean ingredient comprises water less than 5 wt-% based on a total weight of the coffee bean ingredient.

In one embodiment, the coffee bean ingredient comprises whole roasted coffee beans.

In one embodiment, the coffee bean ingredient comprises grinded coffee beans having particles size from 100 μm to 1.2 mm.

In one embodiment, the coffee bean ingredient comprises instant coffee particles.

The present invention is suitable for lowering an acidity of instant coffee, different types of filter coffee or whole coffee beans.

In one embodiment, the composition comprises the coffee bean ingredient from 90 wt-% to 99.5 wt-% based on a total weight of the composition, and the antacid ingredient from 0.5 wt-% to 10 wt-% based on a total weight of the composition.

This provides composition for making a drink having low acidity and fair taste.

In one embodiment, the composition comprises the coffee bean ingredient from 96 wt-% to 99 wt-% based on a total weight of the composition, and the antacid ingredient from 1 wt-% to 4 wt-% based on a total weight of the composition.

This provides composition for making a drink having low acidity and excellent taste.

In one embodiment, the composition comprises the coffee bean ingredient from 94 wt-% to 99 wt-% based on a total weight of the composition, the antacid ingredient from 0.5 wt-% to 3 wt-% based on a total weight of the composition, and a polysaccharide ingredient from 0.5 wt-% to 3 wt-% based on a total weight of the composition.

This provides composition for making a drink having low acidity and excellent taste and polysaccharides providing particles comprising the coffee bean ingredient, the antacid ingredient and the polysaccharide ingredient

In one embodiment, the composition comprises particles comprising the coffee bean ingredient and the antacid ingredient.

This provides particles for making a drink having low acidity such that different particles do not sort during transport.

In one embodiment, the composition comprises particles comprising the coffee bean ingredient, the antacid ingredient and the polysaccharide ingredient.

This provides particles for making a drink having low acidity such that different particles do not sort during transport.

In one embodiment, the composition comprises solid particles comprising the coffee bean ingredient, the antacid ingredient and the polysaccharide ingredient.

In one embodiment, the composition comprises particles comprising the coffee bean ingredient, the antacid ingredient and the polysaccharide ingredient, and the polysaccharide ingredient and the antacid ingredient are arranged to form a film on the coffee bean ingredient.

This provides particles for making a drink having low acidity such that different particles do not sort during transport.

In one embodiment, the composition comprises particles comprising the coffee bean ingredient, the antacid ingredient and the polysaccharide ingredient, and the antacid ingredient is attached on the coffee bean ingredient with the polysaccharide ingredient.

Such particles are durable.

The present invention further relates to a method for producing a composition for making a drink. The method comprises following steps preparing a coffee bean ingredient comprising water less than 15 wt-% based on a total weight of the coffee bean ingredient, preparing a drink additive comprising an antacid ingredient and mixing together the coffee bean ingredient and the drink additive.

The composition comprises the coffee bean ingredient from 80 wt-% to 99 wt-% based on a total weight of the composition, the antacid ingredient from 0.5 wt-% to 10 wt-% based on a total weight of the composition, and a polysaccharide ingredient from 0.5 wt-% to 10 wt-% based on a total weight of the composition. The step of preparing a drink additive comprises preparing a first drink additive comprising antacid ingredient and preparing a second drink additive comprising the polysaccharide ingredient comprising an extract from mushroom. The step of mixing together the coffee bean ingredient and the drink additive comprises mixing together the coffee bean ingredient, the first drink additive and the second drink additive. The method further comprises drying the composition, the step of drying the composition being after the step of mixing together the coffee bean ingredient and the drink additive.

In one embodiment, the step of preparing a coffee bean ingredient comprises providing roasted coffee beans.

In one embodiment, providing roasted coffee beans and grinding roasted coffee beans into the coffee bean ingredient comprising particles size from 100 μm to 1.2 mm.

In one embodiment, providing green coffee beans and roasting the green coffee beans at a temperature in the range of 150 to 250° C. In one embodiment, providing green coffee beans and roasting the green coffee beans at a temperature in the range of 150 to 250° C. and cooling the roasted coffee beans to temperature less than 40° C. after the step of roasting the coffee beans.

In one embodiment, providing green coffee beans and roasting the green coffee beans at a temperature in the range of 150 to 250° C., cooling the roasted coffee beans to temperature less than 40° C. after the step of roasting the coffee beans, and grinding roasted coffee beans into the coffee bean ingredient comprising particles size from 100 μm to 1.2 mm.

Various types of coffees may be produced according to the method of the present invention.

Various types of coffee raw material are suitable for the method of the present invention.

In one embodiment, the method further comprises drying the composition, the step of drying the composition being after the step of mixing together the coffee bean ingredient and the drink additive.

The dried composition is easy store before it is used for making a drink. In one embodiment, drying the composition with hot air, the step of drying the composition with hot air being carried out after the step of mixing together the coffee bean ingredient and the drink additive.

The dried composition is easy store before it is used for making a drink. Drying with hot air is efficient way to dry the composition.

In one embodiment, the step of preparing a drink additive comprises providing water and the antacid ingredient, and the step of preparing a drink additive further comprises mixing water from 40 wt-% to 60 wt-% based on a total weight of the drink additive and the antacid ingredient from 40 wt-% to 60 wt-% based on a total weight of the drink additive.

Such composition is easy to mix with the coffee bean ingredient.

In one embodiment, the step of preparing a drink additive comprises providing water and the antacid ingredient, and the step of preparing a drink additive further comprises mixing water from 40 wt-% to 60 wt-% based on a total weight of the drink additive and the antacid ingredient from 40 wt-% to 60 wt-% based on a total weight of the drink additive; and the step of mixing together the coffee bean ingredient and the drink additive comprises mixing together the coffee bean ingredient from 94 wt-% to 99 wt-% based on a total weight of the composition and the drink additive from 1 wt-% to 6 wt-% based on a total weight of the composition.

Such composition is easy to mix with the coffee bean ingredient.

In one embodiment, the step of preparing a drink additive comprises providing water, an antacid ingredient, and a polysaccharide ingredient, and the step of preparing a drink additive further comprises mixing together water, the antacid ingredient and the polysaccharide ingredient.

Such composition is easy to mix with the coffee bean ingredient.

In one embodiment, the step of preparing a drink additive comprises providing water, the antacid ingredient, and a polysaccharide ingredient, and the step of preparing a drink additive comprises mixing together water from 20 wt-% to 35 wt-% based on a total weight of the drink additive, the antacid ingredient from 20 wt-% to 35 wt-% based on a total weight of the drink additive and the polysaccharide ingredient form 20 wt-% to 35 wt-% based on a total weight of the drink additive; and the step of mixing together the coffee bean ingredient and the drink additive comprises mixing together the coffee bean ingredient from 92 wt-% to 98 wt-% based on a total weight of the composition and the drink additive from 2 wt-% to 8 wt-% based on a total weight of the composition.

Such composition is easy to mix with the coffee bean ingredient.

The ratio of amount of the polysaccharide ingredient and the antacid ingredient is in range of 0,65 to 1,5 based on a weight of the polysaccharide ingredient and a weight of the antacid ingredient.

In one embodiment, the step of preparing a drink additive comprises preparing a first drink additive comprising antacid ingredient and preparing a second drink additive comprising the polysaccharide ingredient; and the step of mixing together the coffee bean ingredient and the drink additive comprises mixing together the coffee bean ingredient, the first drink additive and the second drink additive.

In one embodiment, the step of preparing a drink additive comprises preparing a first drink additive comprising antacid ingredient and preparing a second drink additive comprising the polysaccharide ingredient; and the step of mixing together the coffee bean ingredient and the drink additive comprises mixing together first the coffee bean ingredient and the first drink additive and then mixing the coffee bean ingredient and the first drink additive together with the second drink additive.

In one embodiment, the step of preparing a drink additive comprises preparing a first drink additive comprising antacid ingredient and preparing a second drink additive comprising the polysaccharide ingredient; and the step of mixing together the coffee bean ingredient and the drink additive comprises mixing together first the coffee bean ingredient and the first drink additive and then mixing the coffee bean ingredient and the first drink additive together with the second drink additive.

In one embodiment, the step of preparing a drink additive comprises preparing a first drink additive comprising antacid ingredient and preparing a second drink additive comprising the polysaccharide ingredient; and the step of mixing together the coffee bean ingredient and the drink additive comprises mixing together first the coffee bean ingredient and the second drink additive and then mixing the coffee bean ingredient and the second drink additive together with the first drink additive.

In one embodiment, the step of preparing a drink additive comprises preparing a first drink additive comprising antacid ingredient and a second drink additive comprising the polysaccharide ingredient, the first drink additive comprises water from 40 wt-% to 60 wt-% based on a total weight of the first drink additive and the antacid ingredient from 40 wt-% to 60 wt-% based on a total weight of the first drink additive, and the second drink additive comprises water from 20 wt-% to 80 wt-% based on a total weight of the second drink additive and the polysaccharide ingredient from 20 wt-% to 80 wt-% based on a total weight of the second drink additive; and the step of mixing together the coffee bean ingredient and the drink additive comprises mixing together the coffee bean ingredient from 94 wt-% to 99 wt-% based on a total weight of the composition, the first drink additive from 1 wt-% to 4 wt-% based on a total weight of the composition and the second drink additive from 1 wt-% to 4 wt-% based on a total weight of the composition.

In one embodiment, the composition is any of above disclosed compositions.

In one embodiment, the antacid ingredient is any of above disclosed antacid ingredients.

In one embodiment, polysaccharide ingredient is any of above disclosed polysaccharide ingredient.

The present invention further relates to an apparatus for producing a composition for making a drink. The apparatus comprises a drink additive preparation device arranged to prepare a drink additive comprising an antacid ingredient and a mixing device arranged to mix together a coffee bean ingredient and the drink additive.

In one embodiment, the mixing device comprises a drying unit arranged to dry a mixture of the coffee bean ingredient and the drink additive.

In one embodiment, the apparatus comprises a drying device arranged to dry a mixture of the coffee bean ingredient and the drink additive.

In one embodiment, the apparatus comprises a drying device arranged to dry a mixture of the coffee bean ingredient and the drink additive, the drying device comprises a hot air blower.

In one embodiment, the apparatus comprises a drying device arranged to dry a mixture of the coffee bean ingredient and the drink additive, the drying device being a drum dryer.

In one embodiment, the apparatus comprises a drying device arranged to dry a mixture of the coffee bean ingredient and the drink additive, the drying device being a rotary dryer, a tunnel dryer, a trough dryer, a roller dryer, a bin dryer, a fluidized bed dryer, a belt dryer, a spray dryer, a vacuum dryer, a pneumatic dryer, a freeze dryer or a tray dryer.

The dried composition is easy store before it is used for making a drink.

In one embodiment, the apparatus comprises a roasting device arranged to roast green coffee beans.

In one embodiment, the apparatus comprises a roasting device arranged to roast green coffee beans and a cooling device arranged to cool the roasted coffee beans.

In one embodiment, the apparatus comprises a roasting device arranged to roast green coffee beans, a cooling device arranged to cool the roasted coffee beans and a grinding device arranged to grind the roasted coffee beans.

Different raw material may be used in the apparatus according to the present invention.

In one embodiment, the drink additive preparation device further comprises a mixing device arranged to receive and mix liquid, the antacid ingredient and a polysaccharide ingredient.

In one embodiment, the drink additive preparation device comprises a mixing device arranged to receive and mix liquid, the antacid ingredient and polysaccharide ingredient, the drink additive preparation device further comprises a dosing unit arranged to dose liquid, the antacid ingredient and polysaccharide ingredient into the mixing device.

In one embodiment, the drink additive preparation device comprises a first mixing device arranged to receive and mix the antacid ingredient. In one embodiment, the drink additive preparation device comprises a first mixing device arranged to receive and mix the antacid ingredient and a second mixing device arranged to receive and mix liquid and a polysaccharide ingredient.

In one embodiment, the drink additive preparation device comprises a first mixing device arranged to receive the antacid ingredient and a second mixing device arranged to receive and liquid and a polysaccharide ingredient, the drink additive preparation device further comprises a first dosing unit arranged to dose liquid and the antacid ingredient into the first mixing device and a second dosing unit arranged to dose liquid and the polysaccharide ingredient into the second mixing device.

In one embodiment, the apparatus is an apparatus for producing any of above disclosed composition for making a drink.

The present invention further relates to use of an antacid ingredient for lowering acidity of a drink. The antacid ingredient is present in a composition for making the drink, and the composition further comprises a coffee bean ingredient.

The composition further comprises a polysaccharide ingredient comprising an extract from mushroom. The antacid ingredient comprises sodium bicarbonate. The polysaccharide ingredient comprising an extract from mushroom. The composition comprises the coffee bean ingredient from 80 wt-% to 99 wt-% based on a total weight of the composition, the antacid ingredient from 0.5 wt-% to 10 wt-% based on a total weight of the composition, and a polysaccharide ingredient from 0.5 wt-% to 10 wt-% based on a total weight of the composition. The composition comprises particles comprising the coffee bean ingredient, the antacid ingredient and the polysaccharide ingredient.

In one embodiment, the drink is made with water and the composition.

In one embodiment, the drink is made with water and the composition, and a pH of the drink is selected to be in the range of pH 5,7 to 7,3.

In one embodiment, the drink is made with water and the composition, and a pH of the drink is selected to be higher than 5, 7.

In one embodiment, the drink is made with alkaline water and the composition.

In one embodiment, the drink is made with alkaline water and the composition, the alkaline water having a pH in the range of 8 to 9, and a pH of the drink is selected to be higher than 6,5.

In one embodiment, the drink is made with alkaline water and the composition, the alkaline water having a pH in the range of 8 to 9, and a pH of the drink is selected to be in the range of 6,5 to 7,3.

The alkaline water further lower acidity of the drink such that is does not affect taste.

In one embodiment, the composition is any above disclosed composition for making a drink.

An advantage of the invention is that it provides the composition for making a drink such that the drink tastes coffee and has low acidity.

The invention further provides a method for producing the composition for a drink such that the drink tastes coffee and has low acidity.

The invention further provides an apparatus for producing a composition and more particularly to an apparatus for producing a composition for a drink such that the drink tastes coffee and has low acidity.

The present invention further relates to use of an antacid ingredient for lowering acidity of a drink such the antacid ingredient is present in a composition for making the drink.

Furthermore, the antacid is present in the composition in a form which does sort from the coffee bean ingredient.

Furthermore, polysaccharide ingredient comprising natural extracts prolonging an effect of the caffeine and at the same time for providing particles comprising the antacid ingredient, the coffee bean ingredient and the polysaccharide ingredient.

Particularly, polysaccharide ingredient comprising natural extracts prolonging an effect of the caffeine and at the same time for providing particles comprising the antacid ingredient, the coffee bean ingredient and the polysaccharide ingredient.

These and other objects, advantages and features of the invention will become apparent upon review of the following specification in conjunction with the drawings.

### BRIEF DESCRIPTION OF THE DRAWINGS

The invention is described in detail by means of specific embodiments with reference to the enclosed drawings, in which

FIGS. 1a and 1b illustrate method aspects of the present invention and its embodiments; and

FIGS. 2a and 2b show schematically embodiments of an apparatus for producing a composition according to the present invention.

### DESCRIPTION OF THE PREFERRED EMBODIMENTS

In this invention a composition of matter means a combination of two or more substances and includes all composite articles. This category includes all compositions of two or more substances, two or more ingredients and all composite articles, whether they be the results of chemical union or of mechanical mixture, or whether they be gases, fluids, powders or solids.

The present invention relates to a composition for making a drink, the composition comprises a coffee bean ingredient and an antacid ingredient.

In one embodiment, the antacid ingredient comprises a salt of aluminium, a salt of calcium, a salt of magnesium, a salt of sodium, magnesium carbonate, aluminium hydroxide or a combination thereof.

In one embodiment, the antacid ingredient comprises sodium bicarbonate.

In one embodiment, the antacid ingredient comprises sodium carbonate.

In one embodiment, the antacid ingredient consists of sodium bicarbonate.

In one embodiment, the composition further comprises a polysaccharide ingredient.

In one embodiment, the composition further comprises a polysaccharide ingredient comprising a natural extract comprising polysaccharides.

Polysaccharides are carbohydrates whose molecules consist of a number of sugar molecules bonded together.

A natural extract is a substance made by extracting a part of a raw material, often by using a solvent such as ethanol, oil or water. The raw material may be from plants, algae or mushroom.

In one embodiment, the composition further comprises a polysaccharide ingredient comprising an extract from mushroom.

The extract from mushroom may be for instance, an extract from reishi, cordyceps, Antrodia camphorate, Turkey Tail Mushroom, Lion's Mane Mushroom, Phellinus Igniarius, Tremella Mushroom, Maitake Mushroom, Enoki Mushroom, Agaricus Blazei Mushroom, Chaga Mushroom, Poria or Shiitake Mushroom.

Polysaccharopeptides (PSP) are protein-bound polysaccharides (carbohydrates) that are found in mushroom extracts. The therapeutic properties of mushrooms result from specific active constituents. These consist mainly of polysaccharides and in particular beta-d-glucans, PSP, polysaccharide proteins and proteins. Other bioactive substances including triterpenes, lipids and phenols are also identified.

In one embodiment, the composition further comprises a polysaccharide ingredient comprising an extract from gingseng.

In one embodiment, the composition further comprises a polysaccharide ingredient comprising a natural extract, the natural extract comprises polysaccharides from 10 wt-% to 90 wt-% based on a total weight of the extract.

In one embodiment, the composition further comprises a polysaccharide ingredient comprising a natural extract, the natural extract comprises polysaccharides from 25 wt-% to 35 wt-% based on a total weight of the extract.

In one embodiment, the composition further comprises a polysaccharide ingredient comprising an extract from mushroom, the extract from mushroom comprises polysaccharides from 10 wt-% to 90 wt-% based on a total weight of the extract.

In one embodiment, the composition further comprises a polysaccharide ingredient comprising an extract from mushroom, the extract from mushroom comprises polysaccharides from 25 wt-% to 35 wt-% based on a total weight of the extract.

In one embodiment, the composition comprises water less than 15 wt-% based on a total weight of the coffee bean ingredient.

In one embodiment, the coffee bean ingredient comprises water less than 5 wt-% based on a total weight of the coffee bean ingredient.

In one embodiment, the coffee bean ingredient comprises whole roasted coffee beans.

In one embodiment, the coffee bean ingredient comprises grinded coffee beans having particles size from 100 μm to 1.2 mm.

In one embodiment, the coffee bean ingredient comprises grinded coffee beans having particles size from 0.3 mm to 1.2 mm.

In one embodiment, the coffee bean ingredient comprises grinded coffee beans having particles size from 0.8 mm to 1.2 mm.

In one embodiment, the coffee bean ingredient comprises grinded coffee beans having particles size from 0.65 mm to 0.8 mm.

In one embodiment, the coffee bean ingredient comprises grinded coffee beans having particles size from 0.3 mm to 0.5 mm.

In one embodiment, the coffee bean ingredient comprises grinded coffee beans having particles size from 100 μm to 400 μm.

Coffee compositions can be provided to a coffee consumer in several different forms. Some consumers prefer to be provided with whole roasted coffee beans, which they grind themselves immediately before brewing. Other consumers find it more convenient to be provided with pre-ground roasted coffee, which they then brew. Other consumers prefer using instant coffee.

The present invention is suitable for coffee ingredient of instant coffee, filter coffee or whole coffee beans.

In one embodiment, the composition comprises the coffee bean ingredient from 90 wt-% to 99.5 wt-% based on a total weight of the composition, and the antacid ingredient from 0.5 wt-% to 10 wt-% based on a total weight of the composition.

In one embodiment, the composition comprises the coffee bean ingredient from 96 wt-% to 99 wt-% based on a total weight of the composition, and the antacid ingredient from 1 wt-% to 4 wt-% based on a total weight of the composition.

In one embodiment, the composition comprises the coffee bean ingredient from 80 wt-% to 99 wt-% based on a total weight of the composition, the antacid ingredient from 0.5 wt-% to 10 wt-% based on a total weight of the composition, and a polysaccharide ingredient from 0.5 wt-% to 10 wt-% based on a total weight of the composition.

In one embodiment, the composition comprises the coffee bean ingredient from 94 wt-% to 99 wt-% based on a total weight of the composition, the antacid ingredient from 0.5 wt-% to 3 wt-% based on a total weight of the composition, and a polysaccharide ingredient from 0.5 wt-% to 3 wt-% based on a total weight of the composition.

In one embodiment, the composition comprises particles comprising the coffee bean ingredient and the antacid ingredient.

In one embodiment, the composition comprises particles comprising the coffee bean ingredient, the antacid ingredient and the polysaccharide ingredient.

In one embodiment, the composition comprises solid particles comprising the coffee bean ingredient, the antacid ingredient and the polysaccharide ingredient.

In one embodiment, the composition comprises particles comprising the coffee bean ingredient, the antacid ingredient and the polysaccharide ingredient, and the polysaccharide ingredient and the antacid ingredient are arranged to form a film on the coffee bean ingredient.

In one embodiment, the composition comprises particles comprising the coffee bean ingredient, the antacid ingredient and the polysaccharide ingredient, and the antacid ingredient is attached on the coffee bean ingredient with the polysaccharide ingredient.

A coffee bean is a seed of the coffea plant and the source for coffee. It is the pip inside the red or purple fruit often referred to as a cherry. Just like ordinary cherries, the coffee fruit is also a so-called stone fruit. Even though the coffee beans are not technically beans, they are referred to as such because of their resemblance to true beans. The seeds of botanical genus Coffea may be raw, roasted, whole, or ground.

The main constituents of coffee beans are caffeine, tannin, fixed oil, carbohydrates, and proteins. Typically, it contains 2-3% caffeine, 3-5% tannins, 13% proteins, and 10-15% fixed oils. In the seeds, caffeine is present as a salt of chlorogenic acid (CGA). Also it contains oil and wax.

The main ingredients in coffee beans are Caffeine, Tannin, Thiamin, Xanthine, Spermidine, Guaiacol, Citric acid, Chlorogenic acid. Acetaldehyde, Spermine, Putrescine and Scopoletin.

The various constituents along with components of coffee are shown in Table 1.

| Constituent | Components |
|---|---|
| Soluble carbohydrates | Monosaccharides Fructose, glucose, galactose, |
| | arabinose (traces) |
| Oligosaccharides | Sucrose, raffinose, stachyose |
| Polysaccharides | Polymers of galactose, mannose, arabinose, |
| | glucose, Insoluble polysaccharides |
| Hemicelluloses | Polymers of galactose, arabinose, mannose, |
| | Cellulose Acids and phenols, Volatile acids, |
| Nonvolatile aliphatic | Citric acid, malic acid, quinic acid |
| acids | |
| Chlorogenic acids | Mono-, dicaffeoyl- and feruloylquinic acid, |
| | Lignin, Lipids, Wax |
| Oil | Main fatty acids: N Compounds |
| Free amino acids | Main amino acids: Glu, Asp, Asp-NH2, Proteins |
| Coffeine | Traces of theobromine and theophylline, |
| | Trigonelline, Minerals |

Most of the carbohydrates present, such as cellulose and polysaccharides consisting of mannose, galactose, and arabinose, are insoluble.

Typically, the lipid fraction is stable, and it comprising following composition:
Linoleic acid is the predominant fatty acid, followed by palmitic acid, Lipid composition, Triacylglycerols, Diterpene esters, Diterpenes, Triterpene esters, Triterpenes (sterols).

The volatile acids include formic acids and acetic acids, while nonvolatile acids include lactic, tartaric, pyruvic, and citric acid. Minor constituents include higher fatty acids and malonic, succinic, glutaric, and malic acids. The degradation products of citric acid are itaconic (1), citraconic (11), and mesaconic acids (III), while fumaric and maleic acids are degraded products of malic acid. Chlorogenic acids are the mainly rich acids of coffee.

Coffee beans contains trigonelline (N-methylnicotinic acid) up to 0.6% and is 50% decomposed during roasting. The degradants include nicotinic acid, pyridine, 3-methyl pyridine, nicotinic acid, methyl ester, and other compounds.

Coffee beans comprise typically, potassium (1.1%), calcium (0.2%), and magnesium (0.2%). The major anions includes phosphate (0.2%) and sulfate (0.1%), along with traces of other elements

[Hemraj Sharma (Mar. 20th 2020). A Detail Chemistry of Coffee and Its Analysis, Coffee-Production and Research, Dalyse Toledo Castanheira,

IntechOpen, DOI: 10.5772/intechopen.91725. Available from:
https://www.intechopen.com/chapters/71528]

### Example 1 (Comparative Example)

Coffee was prepared such that:
2 dl neutral water was poured on 15 g grinded coffee on a filter.
Coffee had pH 5 and a good taste.

### Example 2 (According to Present Invention)

Coffee was prepared such that:
200 g of baking soda and 200 ml of hot water were mixed and sprayed on 13 kg of roasted coffee.
2 dl neutral water was poured on 15 g grinded coffee comprising the baking soda on a filter.

Coffee had pH 6 and an excellent taste.

### Example 3 (According to Present Invention)

Coffee was prepared such that:
A composition was made of baking soda 1.3 wt-% based on a total weight of the composition, mushroom extract in powder form obtained from Ganoderma lucidum (Reishi) fruiting bodies standardized to 30% polysaccharides 2 wt-% based on a total weight of the composition, hot water 1.3 wt-% based on a total weight of the composition and roasted coffee 95.4 wt-% based on a total weight of the composition. 2 dl neutral water was poured on the composition on a filter.

Coffee had pH 6 and an excellent taste. Furthermore, caffeine affected longer in a human body. Furthermore, the inventor surprisingly found out that the composition comprises particles comprising the coffee bean ingredient, the antacid ingredient and the polysaccharide ingredient such that the components did not sort even the composition was stirred. The composition was dried, and the particles being solid particles. Example 4 (according to present invention)

Coffee was prepared such that:
2 dl neutral water was poured on 15 g grinded coffee comprising baking soda 10 wt-% based on a total weight of the composition, the grinded coffee and baking soda were on a filter.

Coffee had a fair taste. This means that upper limit of an amount of baking soda is 10 wt-% based on a total weight of the composition

### Example 5 (According to Present Invention)

Coffee was prepared such that 2 dl neutral water was poured on 15 g grinded coffee comprising baking soda 0.5 wt-%, 1 wt-%, 3 wt-% and 4 wt-% based on a total weight of the composition, the grinded coffee and baking soda were on a filter. The inventor found out that the antacid has some effect when grinded coffee comprising baking soda 0.5 wt-%. Increasing backing soda further lowered the acidity.

### Example 6 (According to Present Invention)

Coffee was prepared such that 2 dl neutral water was poured on 15 g grinded coffee comprising mushroom extract in powder form 0.5 wt-%, 3 wt-% and 10 wt-% based on a total weight of the composition, the grinded coffee and mushroom extract were on a filter. The inventor found out that effect of the mushroom extract was reasonable when coffee comprising mushroom extract in powder form 0.5 wt-%, and there is no reason to exceed 10 wt-%.

According to Example 5 and Example 6 the composition may comprise the coffee bean ingredient from 80 wt-% to 99 wt-% such that the coffee bean ingredient, the antacid ingredient, and the polysaccharide ingredient and water adds up to 100 wt %.

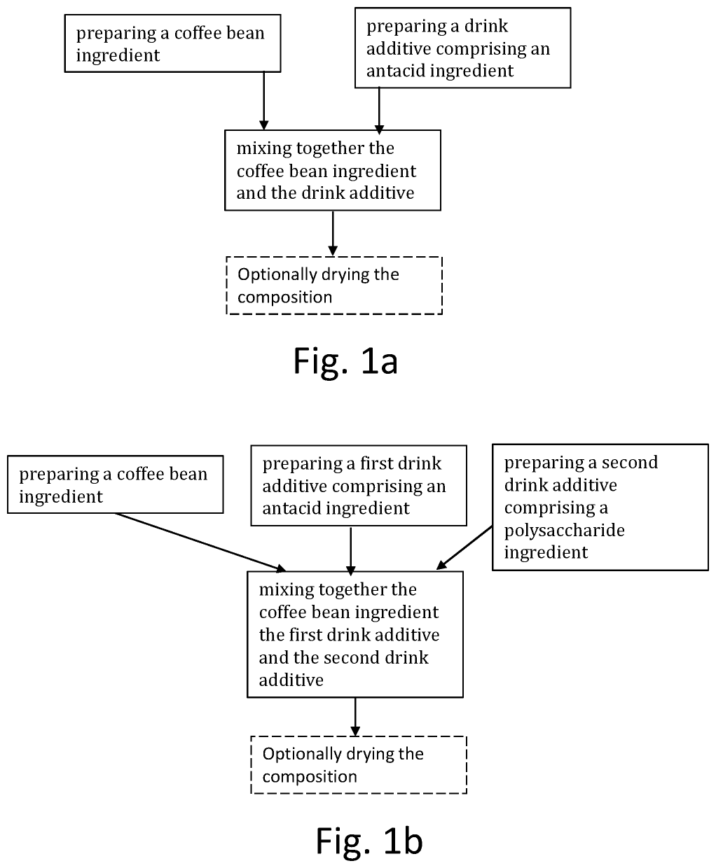

FIG. 1a illustrates a method aspect of the present invention and its embodiments.

The method for producing a composition for making a drink comprises preparing a coffee bean ingredient comprising water less than 15 wt-% based on a total weight of the coffee bean ingredient, preparing a drink additive comprising an antacid ingredient and mixing together the coffee bean ingredient and the drink additive.

The coffee bean ingredient being in a solid form. In other words, the coffee bean ingredient is not in liquid form. This means that the coffee bean ingredient in not a drink. The composition may be used for brewing a drink having a coffee flavour.

The coffee bean ingredient may comprise green coffee beans which means that the coffee beans are not roasted or coffee bean ingredient may comprise roasted coffee beans.

In one embodiment, the step of preparing a coffee bean ingredient comprises providing roasted coffee beans.

In one embodiment, the step of preparing a coffee bean ingredient comprises providing green coffee beans and roasting the green coffee beans at a temperature in the range of 150 to 250° C.

In one embodiment, the step of preparing a coffee bean ingredient comprises providing green coffee beans and roasting the green coffee beans at a temperature in the range of 150 to 250° C. and cooling the roasted coffee beans to temperature less than 40° C. after roasting the coffee beans.

In one embodiment, the step of preparing a coffee bean ingredient comprises providing green coffee beans and roasting the green coffee beans at a temperature in the range of 150 to 250° C. and cooling down the temperature of the roasted coffee beans to less than 40° C. after roasting the green coffee beans, and cooling is performed at a temperature in the range of 15 to 30° C.

In one embodiment, the step of preparing a coffee bean ingredient comprises grinding roasted coffee beans into the coffee bean ingredient comprises particles size from 100 μm to 1.2 mm. It should be noted that in this embodiment, the coffee bean ingredient may comprise traces of coffee bean having different size than 100 μm to 1.2 mm.

In one embodiment, grinding roasted coffee beans into the coffee bean ingredient comprises particles size from 0.3 mm to 1.2 mm. It should be noted that in this embodiment, the coffee bean ingredient may comprise traces of coffee bean having different size than 0.3 mm to 1.2 mm.

In one embodiment, grinding roasted coffee beans into the coffee bean ingredient comprises particles size from 0.8 mm to 1.2 mm. It should be noted that in this embodiment, the coffee bean ingredient may comprise traces of coffee bean having different size than 0.8 mm to 1.2 mm.

In one embodiment, grinding roasted coffee beans into the coffee bean ingredient comprises particles size from 0.65 mm to 0.8 mm. It should be noted that in this embodiment, the coffee bean ingredient may comprise traces of coffee bean having different size than 0.65 mm to 0.8 mm.

In one embodiment, grinding roasted coffee beans into the coffee bean ingredient comprises particles size from 0.3 mm to 0.5 mm. It should be noted that in this embodiment, the coffee bean ingredient may comprise traces of coffee bean having different size than 0.3 mm to 0.5 mm.

In one embodiment, grinding roasted coffee beans into the coffee bean ingredient comprises particles size from 100 μm to 400 μm. It should be noted that in this embodiment, the coffee bean ingredient may comprise traces of coffee bean having different size than 100 μm to 400 μm.

In one embodiment, the method further comprises drying the composition.

In one embodiment, the step of drying the composition being carried out after the step of mixing together the coffee bean ingredient and the drink additive.

In one embodiment, the method comprises drying the composition with hot air, the step of drying the composition with hot air being after the step of mixing together the coffee bean ingredient and the drink additive.

Typically, the water content of the coffee bean ingredient after drying the composition is less than 5 wt-% based on a total weight of the composition.

In one embodiment, the step of preparing a drink additive comprises providing water and the antacid ingredient, and the step of preparing a drink additive further comprises mixing water from 40 wt-% to 60 wt-% based on a total weight of the drink additive and the antacid ingredient from 40 wt-% to 60 wt-% based on a total weight of the drink additive.

In one embodiment, the step of mixing together the coffee bean ingredient and the drink additive comprises mixing together the coffee bean ingredient from 94 wt-% to 99 wt-% based on a total weight of the composition and the drink additive from 1 wt-% to 6 wt-% based on a total weight of the composition.

In one embodiment, the step of preparing a drink additive comprises providing water, an antacid ingredient, and a polysaccharide ingredient, and the step of preparing a drink additive further comprises mixing together water, the antacid ingredient and the polysaccharide ingredient.

In one embodiment, the step of preparing a drink additive comprises providing water, the antacid ingredient, and a polysaccharide ingredient, and the step of preparing a drink additive further comprises mixing together water from 20 wt-% to 35 wt-% based on a total weight of the drink additive, the antacid ingredient from 20 wt-% to 35 wt-% based on a total weight of the drink additive and the polysaccharide ingredient form 20 wt-% to 35 wt-% based on a total weight of the drink additive; and the step of mixing together the coffee bean ingredient and the drink additive comprises mixing together the coffee bean ingredient from 92 wt-% to 99 wt-% based on a total weight of the composition and the drink additive from 1 wt-% to 8 wt-% based on a total weight of the composition.

FIG. 1b illustrates a method aspect of the present invention and its embodiments.

In this embodiment, the step of preparing a drink additive comprises preparing a first drink additive comprising antacid ingredient and preparing a second drink additive comprising the polysaccharide ingredient; and the step of mixing together the coffee bean ingredient and the drink additive comprises mixing together the coffee bean ingredient, the first drink additive and the second drink additive. In other words, the method comprises preparing the first drink additive and the second drink additive separately.

In one embodiment, the step of mixing together the coffee bean ingredient and the drink additive comprises mixing together first the coffee bean ingredient and the first drink additive and then mixing the coffee bean ingredient and the first drink additive together with the second drink additive. In other words, the first drink additive and the second drink additive being mixed separately with the coffee bean ingredient.

In one embodiment, the step of preparing a drink additive comprises preparing a first drink additive comprising antacid ingredient and preparing a second drink additive comprising the polysaccharide ingredient; and the step of mixing together the coffee bean ingredient and the drink additive comprises mixing together first the coffee bean ingredient and the first drink additive and then mixing the coffee bean ingredient and the first drink additive together with the second drink additive. In other words, the second drink additive being mixed with a mixture of the coffee bean ingredient and the first drink additive.

In one embodiment, the step of preparing a drink additive comprises preparing a first drink additive comprising antacid ingredient and preparing a second drink additive comprising the polysaccharide ingredient; and the step of mixing together the coffee bean ingredient and the drink additive comprises mixing together first the coffee bean ingredient and the second drink additive and then mixing the coffee bean ingredient and the second drink additive together with the first drink additive. In other words, the first drink additive being mixed with a mixture of the coffee bean ingredient and the second drink additive.

In one embodiment, the step of preparing a drink additive comprises preparing a first drink additive comprising antacid ingredient and a second drink additive comprising the polysaccharide ingredient, the first drink additive comprises water from 40 wt-% to 60 wt-% based on a total weight of the first drink additive and the antacid ingredient from 40 wt-% to 60 wt-% based on a total weight of the first drink additive, and the second drink additive comprises water from 20 wt-% to 80 wt-% based on a total weight of the second drink additive and the polysaccharide ingredient from 20 wt-% to 80 wt-% based on a total weight of the second drink additive; and the step of mixing together the coffee bean ingredient and the drink additive comprises mixing together the coffee bean ingredient from 94 wt-% to 99 wt-% based on a total weight of the composition, the first drink additive from 1 wt-% to 4 wt-% based on a total weight of the composition and the second drink additive from 1 wt-% to 4 wt-% based on a total weight of the composition.

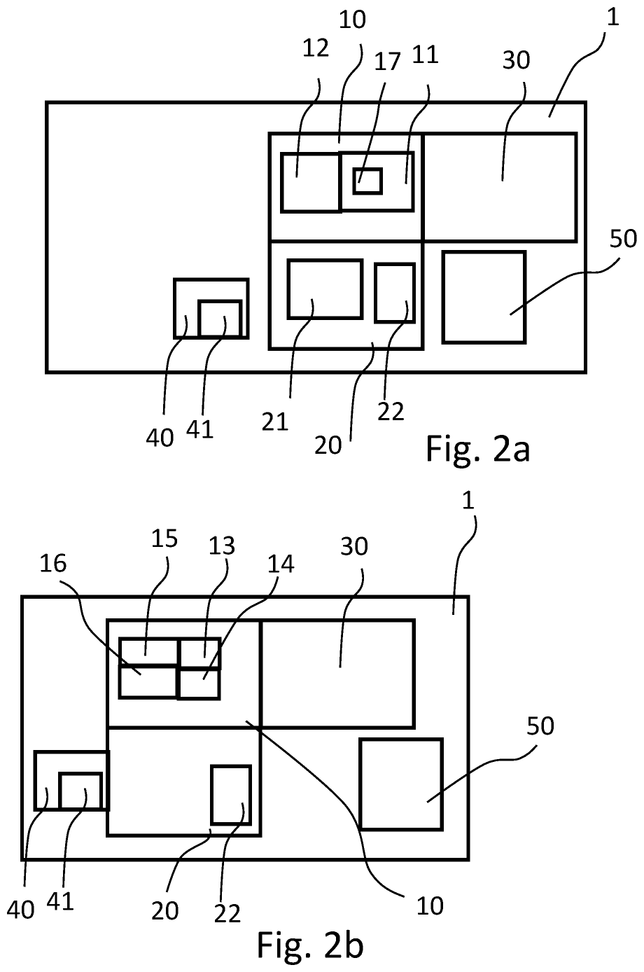

It should be noted that the method according to the present invention may be carried out with any embodiment of apparatus shown in FIGS. 2a and 2b.

FIG. 2a shows schematically an embodiment of an apparatus for producing a composition for making a drink according to the present invention.

The apparatus 1 comprises a drink additive preparation device 10 arranged to prepare a drink additive and a mixing device 20 arranged to mix together a coffee bean ingredient and the drink additive.

In one embodiment, the mixing device 20 comprises a drink additive dosing unit 22 arranged to pour the drink additive onto the coffee bean ingredient.

In an alternative embodiment, the mixing device 20 comprises a drink additive dosing unit 22 arranged to spray the drink additive onto the coffee bean ingredient.

In this embodiment, the apparatus 1 may comprise a drying device 40 arranged to dry a composition of the coffee bean ingredient and the drink additive.

In one embodiment, the drying device 40 comprises a hot air blower 41.

In one embodiment, the drying device 40 being a drum dryer.

The roller or drum drier is essentially a cylinder, disposed marginally to the horizontal, which may be rotated, or the shell may be stationary, and an agitator inside may revolve slowly. In these the composition is spread over the surface of a heated drum. The drum rotates, with the composition being applied to the drum at one part of the cycle. The composition remains on the drum surface for the greater part of the rotation, during which time the drying takes place, and is then scraped off. Drum drying may be regarded as conduction drying

In one embodiment, the drying device 40 being a rotary dryer.

The rotary drier is basically a cylinder, the composition is placed in horizontally inclined cylinder through which it passed, and heated by means of hot air or conduction of heat from walls. Cylinder might be rotational in nature of may be stationary. The composition is fed into cylinder from upper end and the rotation or agitation make the composition travel gradually to lower end, where it gets cleared.

In one embodiment, the drying device 40 being a tunnel dryer.

Tunnel dryers belongs to family of continuous drying process, in this the composition under treatment process travel in comportment, shaped as tunnel and hot air circulating this with in it. In most cases, air is used in tunnel drying and composition can move through the dryer either parallel or counter current to the air flow. Sometimes the dryers are compartmented, and cross-flow may also be used

In one embodiment, the drying device 40 being a trough dryer.

The composition to be dried are contained in a trough-shaped conveyor belt, made from mesh, and air is blown through the bed of material. The movement of the conveyor continually turns over the composition, exposing fresh surfaces to the hot air.

In one embodiment, the drying device 40 being a bin dryer.

In bin dryers, the foodstuff is contained in a bin with a perforated bottom through which warm air is blown vertically upwards, passing through the composition and so drying it.

In one embodiment, the drying device 40 being a fluidized bed dryer.

In a fluidized bed dryer, the composition is maintained suspended against gravity in an upward-flowing air stream. There may also be a horizontal air flow helping to convey the composition through the dryer. Heat is transferred from the air to the composition, mostly by convection.

In one embodiment, the drying device 40 being a belt dryer.

In a belt dryer, the food is spread as a thin layer on a horizontal mesh or solid belt and air passes through or over the composition. In most cases the belt is moving, though in some designs the belt is stationary and the composition is transported by scrapers.

In one embodiment, the drying device 40 being a spray dryer.

In a spray dryer, composition is dried until it achieves status. Air and solids may move in parallel or counterflow. Drying occurs very rapidly, so that this process is very useful for materials that are damaged by exposure to heat for any appreciable length of time. The dryer body is large so that the particles can settle, as they dry, without touching the walls on which they might otherwise stick.

In one embodiment, the drying device 40 being a vacuum dryer.

Batch vacuum dryers are substantially the same as tray dryers, except that they operate under a vacuum, and heat transfer is largely by conduction or by radiation. The trays are enclosed in a large cabinet, which is evacuated. The water vapour produced is generally condensed, so that the vacuum pumps have only to deal with non-condensable gases. Another type consists of an evacuated chamber containing a roller dryer.

In one embodiment, the drying device 40 being a pneumatic dryer.

In pneumatic conveying dryers the powders or granular materials are dried while suspended in a stream of heated air, the solid food particles are conveyed rapidly in an air stream, the velocity and turbulence of the stream maintaining the particles in suspension. In pneumatic dryers, powders or foods are continuously dried in vertical or horizontal metal ducts. A cyclone separator is used to remove the dried product. Some its used in collaboration with the spray dryers to provide second stage of drying.

In one embodiment, the drying device 40 being a freeze dryer.

The material is held on shelves or belts in a chamber that is under high vacuum. In most cases, the composition is frozen before being loaded into the dryer. Heat is transferred to the composition by conduction or radiation and the vapour is removed by vacuum pump and then condensed. In one process, given the name accelerated freeze drying, heat transfer is by conduction; sheets of expanded metal are inserted between the foodstuffs and heated plates to improve heat transfer to the uneven surfaces, and moisture removal. The pieces of composition are shaped so as to present the largest possible flat surface to the expanded metal and the plates to obtain good heat transfer. A refrigerated condenser may be used to condense the water vapour.

In one embodiment, the drying device 40 being a tray dryer.

Tray dryers typically function in batch mode, it comprises of racks to hold product, heating is attained by an air current circulating across the trays, by conduction from heated trays or heated shelves on which the trays lie, or by radiation from heated surfaces. Most tray dryers are heated by air, which also removes the moist vapours.

In one embodiment, the apparatus 1 comprises a roasting device 30 arranged to roast green coffee beans.

For instance, the roasting device may be a drum machine comprising horizontal rotating drums that tumble the green coffee beans in a heated environment. The heat source can be supplied by natural gas, liquefied petroleum gas (LPG), electricity, or even wood. The most common employ indirectly heated drums where the heat source is under the drum. Direct-fired roasters are roasters in which a flame contacts the beans inside the drum; very few of these machines are still in operation. The roasting device may be a fluid bed or hot-air roasters force heated air through a screen or perforated plate under the coffee beans with sufficient force to lift the beans. Heat is transferred to the beans as they tumble and circulate within this fluidized bed.

In one embodiment, the apparatus 1 comprises a cooling device arranged to cool the roasted coffee beans.

Once the beans are roasted, they need to be cooled to avoid changes in quality and aroma. The roasted coffee is cooled by air and water. Cooling time should not take more than a maximum of five minutes. In the air cooling ambient air is passed through roasted coffee beans either in the drum or in a separate cooling unit. In water quench cooling the roasted coffee is cooled by spraying a small amount of water, either in the drum or in a separate cooling unit.

In one embodiment, the apparatus 1 comprises a grinding device 50 arranged to grind the roasted coffee beans.

In one embodiment, the drink additive preparation device 10 further comprises a mixing device 11 arranged to receive and mix liquid, the antacid ingredient and a polysaccharide ingredient.

In one embodiment, the drink additive preparation device 10 comprises a mixing device 11 arranged to receive and mix liquid, the antacid ingredient and polysaccharide ingredient, the drink additive preparation device 10 further comprises a dosing unit 12 arranged to dose liquid, the antacid ingredient and polysaccharide ingredient into the mixing device 11.

In one the drink additive preparation device 10 comprises a first mixing device 13 arranged to receive and mix the antacid ingredient.

In one embodiment, the drink additive preparation device 10 comprises a mixing vessel 11 arranged to receive and mix liquid and the antacid ingredient.

In one embodiment, the drink additive preparation device 10 comprises a mixing vessel 11 arranged to receive and mix water and the antacid ingredient. In one embodiment, the drink additive preparation device 10 comprises a mixing vessel 11 arranged to receive and mix water having a temperature in the range of 30 to 90° C. and the antacid ingredient.

In one embodiment, mixing device 1 comprises a mixing vessel 17 arranged to receive water having a temperature in the range of 50 to 70° C. and the antacid ingredient.

In one alternative embodiment, the drink additive preparation device 10 comprises mixing vessel 17 arranged to receive liquid, the antacid ingredient and a polysaccharide ingredient.

The mixing device may any commonly industrial mixer for instance a tank mixer.

FIG. 2b shows schematically an embodiment of an apparatus for producing a composition for making a drink according to the present invention.

In this embodiment, the drink additive preparation device 10 comprises a first mixing device and a second mixing device 14.

In one embodiment, the drink additive preparation device 10 comprises the first mixing device 13 arranged to receive and mix the antacid ingredient and the second mixing device 14 arranged to receive and mix liquid and a polysaccharide ingredient.

In one embodiment, the drink additive preparation device 10 comprises a first mixing device 13 arranged to receive the antacid ingredient and a second mixing device 14 arranged to receive and liquid and a polysaccharide ingredient, the drink additive preparation device 10 further comprises a first dosing unit 15 arranged to dose liquid and the antacid ingredient into the first mixing device 13 and a second dosing unit 16 arranged to dose liquid and the polysaccharide ingredient into the second mixing device 14.

Other embodiment of the apparatus 1 shown in FIG. 2a may be present in the embodiments of the apparatus 1 shown in FIG. 2b.

The present invention further relates to use of an antacid ingredient for lowering acidity of a drink, the antacid ingredient is present in a composition for making the drink, and the composition further comprises a coffee bean ingredient. In one embodiment, the drink is made with water and the composition. 30 In one embodiment the water having a temperature in a range of 85 to 100° C. In one embodiment, the drink is made with water and the composition, and pH of the drink is selected to be in the range of pH 5,7 to 7,3 at a temperature 25° C.

In chemistry, pH denoting “potential of hydrogen” or “power of hydrogen”) is a scale used to specify the acidity or basicity of an aqueous solution. Acidic solutions (solutions with higher concentrations of H +ions) are measured to have lower pH values than basic or alkaline solutions. The pH scale is logarithmic and inversely indicates the concentration of hydrogen ions in the solution. This is because the formula used to calculate pH approximates the negative of the base 10 logarithm of the molar concentration of hydrogen ions in the solution. More precisely, pH is the negative of the base 10 logarithm of the activity of the H+ ion. At 25° C., solutions with a pH less than 7 are acidic, and solutions with a pH greater than 7 are basic. Solutions with a pH of 7 at this temperature are neutral (e.g. pure water). The neutral value of the pH depends on the temperature-being lower than 7 if the temperature increases.

In one embodiment, the drink is made with water and the composition, and a pH of the drink is selected to be higher than 5, 7 at a temperature 25° C.; or

In one embodiment, the drink is made with alkaline water and the composition.

The alkaline water has pH higher that 7. The alkaline water may be produced with a water ionizer (also known as an alkaline ionizer). The water ionizer is an appliance which raises the pH of drinking water by using electrolysis to separate the incoming water stream into acidic and alkaline components. The alkaline stream of the treated water is called alkaline water.

In one embodiment, the drink is made with alkaline water and the composition, the alkaline water having a pH in the range of 8 to 9 at a temperature 25° C., and a pH of the drink is selected to be higher than 6,5 at a temperature 25° C.

In one embodiment, the drink is made with alkaline water and the composition, the alkaline water having a pH in the range of 8 to 9, and a pH of the drink is selected to be in the range of 6,5 to 7,35 at a temperature 25° C.

The composition may be any embodiment of above disclosed embodiment of the composition.

The invention has been described above with reference to the examples shown in the figures. However, the invention is in no way restricted to the above examples but may vary within the scope of the claims.

Changes and modifications in the specifically-described embodiments may be carried out without departing from the principles of the present invention, which is intended to be limited only by the scope of the appended claims as interpreted according to the principles of patent law including the doctrine of equivalents.

1. A composition for making a drink, the composition comprising:
a coffee bean ingredient and an antacid ingredient;
a polysaccharide ingredient comprising an extract from mushroom; and
solid particles comprising the coffee bean ingredient, the antacid ingredient and the polysaccharide ingredient;
wherein the composition comprises the coffee bean ingredient from 80 wt-% to 99 wt-% based on a total weight of the composition, the antacid ingredient from 0.5 wt-% to 10 wt-% based on the total weight of the composition, and the polysaccharide ingredient from 0.5 wt-% to 10 wt-% based on the total weight of the composition.

2. The composition according to claim 1, wherein the antacid ingredient comprises a salt of aluminium, a salt of calcium, a salt of magnesium, a salt of sodium, magnesium carbonate, aluminium aluminum hydroxide or a combination thereof.

3. The composition according to claim 1, wherein the antacid ingredient comprises sodium bicarbonate, or sodium carbonate, or consists of sodium bicarbonate.

4. The composition according to claim 1, wherein the polysaccharide ingredient comprises β-glucan, β-1,6-glucan, chitin, acidic polysaccharide ginsenan PA and acidic polysaccharide ginsenan PB, or any combination thereof.

5. The composition according to claim 1, wherein:
the composition comprises water less than 15 wt-% based on the total weight of the composition; or
the coffee bean ingredient comprises water less than 5 wt-% based on a total weight of the coffee bean ingredient; or
the coffee bean ingredient comprises whole roasted coffee beans; or
the coffee bean ingredient comprises grinded coffee beans having particles size from 100 μm to 1.2 mm; or
the coffee bean ingredient comprises grinded coffee beans having particles size from 0.3 mm to 1.2 mm; or
the coffee bean ingredient comprises grinded coffee beans having particles size from 0.8 mm to 1.2 mm; or
the coffee bean ingredient comprises grinded coffee beans having particles size from 0.65 mm to 0.8 mm; or
the coffee bean ingredient comprises grinded coffee beans having particles size from 0.3 mm to 0.5 mm; or
the coffee bean ingredient comprises grinded coffee beans having particles size from 100 μm to 400 μm; or
the coffee bean ingredient comprises instant coffee particles.

6. The composition according to claim 1, wherein:
the composition comprises the coffee bean ingredient from 96 wt-% to 99 wt-% based on the total weight of the composition, and the antacid ingredient from 1 wt-% to 4 wt-% based on the total weight of the composition; or
the composition comprises the coffee bean ingredient from 94 wt-% to 99 wt-% based on the total weight of the composition, the antacid ingredient from 0.5 wt-% to 3 wt-% based on the total weight of the composition, and a polysaccharide ingredient from 0.5 wt-% to 3 wt-% based on the total weight of the composition.

7. The composition according to claim 1, wherein:
the composition comprises particles comprising the coffee bean ingredient, the antacid ingredient and the polysaccharide ingredient, and wherein the-polysaccharide ingredient and the antacid ingredient are arranged to form a film on the coffee bean ingredient; or
the composition comprises particles comprising the coffee bean ingredient, the antacid ingredient and the polysaccharide ingredient, and wherein the antacid ingredient is attached on the coffee bean ingredient with the polysaccharide ingredient.

8. A method of producing a composition for making a drink, the composition comprising a coffee bean ingredient from 80 wt-% to 99 wt-% based on a total weight of the composition, an antacid ingredient from 0.5 wt-% to 10 wt-% based on the total weight of the composition, and a polysaccharide ingredient from 0.5 wt-% to 10 wt-% based on the total weight of the composition, the method comprising:
preparing the coffee bean ingredient comprising water less than 15 wt % based on a total weight of the coffee bean ingredient;
preparing a drink additive, the step of preparing the drink additive comprising preparing a first drink additive that includes the antacid ingredient and preparing a second drink additive that includes the polysaccharide ingredient comprising an extract from mushroom;
mixing together the coffee bean ingredient and the drink additive, the step of mixing together the coffee bean ingredient and the drink additive comprises mixing together the coffee bean ingredient, the first drink additive and the second drink additive; and
drying the composition, the step of drying the composition being performed after the step of mixing together the coffee bean ingredient and the drink additive.

9. The method according to claim 8, wherein the step of preparing the coffee bean ingredient comprises:
providing roasted coffee beans; or
providing roasted coffee beans and grinding roasted coffee beans into the coffee bean ingredient comprising particles size from 100 μm to 1.2 mm; or
providing green coffee beans and roasting the green coffee beans at a temperature in the range of 150 to 250° C.; or
providing green coffee beans and roasting the green coffee beans at a temperature in the range of 150 to 250° C. and cooling the roasted coffee beans to temperature less than 40° C. after the step of roasting the coffee beans; or
providing green coffee beans and roasting the green coffee beans at a temperature in the range of 150 to 250° C., cooling the roasted coffee beans to temperature less than 40° C. after the step of roasting the coffee beans, and grinding roasted coffee beans into the coffee bean ingredient comprising particles size from 100 μm to 1.2 mm.

10. The method according to claim 8, wherein the step of drying the composition comprises drying the composition with hot air.

11. The method according to claim 8, wherein:
the step of preparing the drink additive comprises providing water and the antacid ingredient, and mixing the water from 40 wt-% to 60 wt-% based on a total weight of the drink additive and the antacid ingredient from 40 wt-% to 60 wt-% based on the total weight of the drink additive; or
the step of preparing the drink additive comprises providing water and the antacid ingredient, and mixing the water from 40 wt-% to 60 wt-% based on a total weight of the drink additive and the antacid ingredient from 40 wt-% to 60 wt-% based on the total weight of the drink additive, and wherein the step of mixing together the coffee bean ingredient and the drink additive comprises mixing together the coffee bean ingredient from 94 wt-% to 99 wt-% based on the total weight of the composition and the drink additive from 1 wt-% to 6 wt-% based on the total weight of the composition; or
the step of preparing the drink additive comprises providing water, the antacid ingredient, and the polysaccharide ingredient, and wherein the step of preparing the drink additive further comprises mixing together the water, the antacid ingredient and the polysaccharide ingredient; or
the step of preparing the drink additive comprises providing water, the antacid ingredient, and the polysaccharide ingredient, and wherein the step of preparing the drink additive comprises mixing together water from 20 wt-% to 35 wt-% based on the total weight of the drink additive, the antacid ingredient from 20 wt-% to 35 wt % based on the total weight of the drink additive and the polysaccharide ingredient form 20 wt-% to 35 wt-% based on the total weight of the drink additive, and wherein the step of mixing together the coffee bean ingredient and the drink additive comprises mixing together the coffee bean ingredient from 92 wt-% to 98 wt-% based on the total weight of the composition and the drink additive from 2 wt-% to 8 wt-% based on the total weight of the composition.

12. The method according to claim 8, wherein:
the step of mixing together the coffee bean ingredient and the drink additive comprises mixing together first the coffee bean ingredient and the first drink additive and then mixing the coffee bean ingredient and the first drink additive together with the second drink additive; or
the step of mixing together the coffee bean ingredient and the drink additive comprises mixing together first the coffee bean ingredient and the second drink additive and then mixing the coffee bean ingredient and the second drink additive together with the first drink additive.

13. The method according to claim 8, wherein the first drink additive comprises water from 40 wt-% to 60 wt-% based on a total weight of the first drink additive and the antacid ingredient from 40 wt-% to 60 wt-% based on the total weight of the first drink additive, wherein the second drink additive comprises water from 20 wt-% to 80 wt-% based on a total weight of the second drink additive and the polysaccharide ingredient from 20 wt-% to 80 wt-% based on the total weight of the second drink additive, and wherein the step of mixing together the coffee bean ingredient and the drink additive comprises mixing together the coffee bean ingredient from 94 wt-% to 99 wt-% based on the total weight of the composition, the first drink additive from 1 wt-% to 4 wt-% based on the total weight of the composition and the second drink additive from 1 wt-% to 4 wt-% based on the total weight of the composition.

14. An apparatus for producing a composition for making a drink, the apparatus comprising:
a drink additive preparation device arranged to prepare a drink additive comprising an antacid ingredient; and
a mixing device arranged to mix together a coffee bean ingredient and the drink additive.

15. The apparatus according to claim 14, characterized in that wherein:
the mixing device comprises a drying unit arranged to dry a mixture of the coffee bean ingredient and the drink additive; or
the apparatus comprises a drying device arranged to dry a mixture of the coffee bean ingredient and the drink additive; or
the apparatus comprises the drying device arranged to dry a mixture of the coffee bean ingredient and the drink additive, the drying device comprising a hot air blower; or
the apparatus comprises the drying device arranged to dry the mixture of the coffee bean ingredient and the drink additive, the drying device being a drum dryer; or
the apparatus comprises the drying device arranged to dry the mixture of the coffee bean ingredient and the drink additive, the drying device being a rotary dryer, a tunnel dryer, a trough dryer, a roller dryer, a bin dryer, a fluidized bed dryer, a belt dryer, a spray dryer, a vacuum dryer, a pneumatic dryer, a freeze dryer, or a tray dryer.

16. The apparatus according to claim 14, the apparatus further comprising:
a roasting device arranged to roast green coffee beans; or
the roasting device arranged to roast green coffee beans and a cooling device arranged to cool the roasted coffee beans; or
the roasting device arranged to roast green coffee beans, the cooling device arranged to cool the roasted coffee beans and a grinding device arranged to grind the roasted coffee beans.

17. The apparatus according to claim 14, wherein:
the drink additive preparation device further comprises a mixing device arranged to receive and mix liquid, the antacid ingredient and a polysaccharide ingredient; or
the drink additive preparation device comprises a mixing device arranged to receive and mix liquid, the antacid ingredient and polysaccharide ingredient, the drink additive preparation device further comprises a dosing unit arranged to dose liquid, the antacid ingredient and polysaccharide ingredient into the mixing device; or
the drink additive preparation device comprises a first mixing device arranged to receive and mix the antacid ingredient; or
the drink additive preparation device comprises the first mixing device arranged to receive and mix the antacid ingredient and a second mixing device arranged to receive and mix liquid and a polysaccharide ingredient; or
the drink additive preparation device comprises the first mixing device arranged to receive the antacid ingredient and the second mixing device arranged to receive liquid and the polysaccharide ingredient, the drink additive preparation device further comprises a first dosing unit arranged to dose liquid and the antacid ingredient into the first mixing device and a second dosing unit arranged to dose liquid and the polysaccharide ingredient into the second mixing device.

18-20. (canceled)
